(19) United States
(12) Patent Application Publication
(10) Pub. No.: US 2008/0230164 A1
(43) Pub. Date: Sep. 25, 2008

(54) Pneumatic Tire

(75) Inventor: Kazuma Nishitani, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/039,866

(22) Filed: Feb. 29, 2008

(30) Foreign Application Priority Data
Mar. 19, 2007 (JP) 2007-071054

(51) Int. Cl. B60C 11/13

(52) U.S. Cl. 152/209.18

(57) ABSTRACT

A pneumatic tire in which a tread surface is provided with a main groove extending as a straight shape in a tire circumferential direction, and a block row formed by arranging a plurality of blocks facing to the main groove in the tire circumferential direction, the block row has a plurality of first blocks in which a wall surface facing to the main groove is chamfered, and a plurality of second blocks arranged between the first blocks and in which a position in a tire width direction of an edge portion of a wall surface facing to the main groove is differentiated from the first block.

### BACKGROUND OF THE INVENTION

1. Field of the Invention

The present invention relates to a pneumatic tire in which a tread surface is provided with a main groove extending as a straight shape in a tire circumferential direction, and a block row structured such that a plurality of blocks facing to the main groove are arranged in the tire circumferential direction.

2. Description of the Related Art

As one of factors affecting a rectilinear propagation stability of a vehicle, there has been known a wandering (a groove wander) caused by a rain groove. The rain groove is a groove provided for securing a traveling stability at a time of raining, and is formed on a Kyushu Vertically Passing Motor Road, a freeway in California, U.S.A. and the like. Generally, the rain groove is provided so as to be spaced at a fixed pitch in a road width direction while extending in a forward moving direction at fixed groove width and groove depth.

It is known that an edge portion 20 of a wall surface of a land portion provided on a tread surface drops within a rain groove RG so as to generate a lateral force F as shown in FIG. 6, whereby the groove wander is generated. Further, a reaction force caused by a collision between the drop portion and a groove wall of the rain groove RG also causes the wandering of the vehicle. Particularly, in a vehicle having a main groove extending as a straight shape in a tire circumferential direction, since a great lateral force is applied in a stationary manner at a time when the edge portion of the wall surface of the land portion facing to the main groove drops within the rain groove, the wandering of the vehicle is significantly generated, and there is a problem that an obstacle is generated in the rectilinear propagation stability.

In order to prevent the groove wander mentioned above, a pattern design has been conventionally carried out by extending the main groove in a zigzag manner, or defining a suitable arranged position of the main groove. However, since there is a constraint on the other tire characteristics such as a drain performance or the like and a design, a freedom of design is extremely small, and there has been strongly desired to propose a method of suppressing the groove wander regardless of the pattern design.

With regard to this problem, Japanese Unexamined Patent Publication No. 9-39515 and Japanese Unexamined Patent Publication No. 9-71106 propose suppressing the groove wander by chamfering the wall surface of the land portion. In other words, it is possible to suppress the tire from dropping within the rain groove RG by chamfering the wall surface of the land portion so as to set an obtuse edge portion 30 as shown in FIG. 7. However, in the structure mentioned above, although the wandering of the vehicle can be somewhat suppressed, since the lateral force F is applied at a time when the edge portion 30 provided by chamfering drops within the rain groove RG as shown in FIG. 8, and the vehicle wanders, it can not be the that the suppressing effect of the groove wander is sufficient, and it is necessary to further improve the effect.

### SUMMARY OF THE INVENTION

The present invention is made by taking the actual condition mentioned above, and an object of the present invention is to provide a pneumatic tire which can sufficiently suppress a groove wander and can improve a rectilinear propagation stability of a vehicle.

The object can be achieved by the following present invention. That is, the present invention provides a pneumatic tire in which a tread surface is provided with a main groove extending as a straight shape in a tire circumferential direction, and a block row formed by arranging a plurality of blocks facing to the main groove in the tire circumferential direction,

wherein the block row has a plurality of first blocks in which a wall surface facing to the main groove is chamfered, and a plurality of second blocks arranged between the first blocks and in which a position in a tire width direction of an edge portion of a wall surface facing to the main groove is differentiated from the first block.

In the pneumatic tire in accordance with the present invention, since the block row has the first block and the second block as mentioned above, the position in the tire width direction of the edge portion of the wall surface facing to the main groove is not defined, but fluctuates in correspondence to the block. Accordingly, even if the edge portion of the wall surface of any one block of the first and second blocks drops within the rain groove, there is a case that the edge portion of the wall surface of the subsequent other block can be grounded on the road surface without dropping within the rain groove. Even if the edge portion of the wall surface of the other block further drops within the rain groove, it is possible to differentiate the dropping amount because the position in the tire width direction is differentiated from the edge portion which first drops. As a result, it is possible to restrict the generation of the lateral force to only a brief one so as to prevent the lateral force from being applied in a stationary manner, and it is possible to sufficiently suppress the groove wander so as to increase the rectilinear propagation stability of the vehicle.

In the above structure, it is preferable that the second block is structured such that a wall surface facing to the main groove is not chamfered. In accordance with the structure mentioned above, since it is possible to greatly and securely differentiate the position in the tire width direction of the edge portion of the wall surface of the second block from the first block, it is possible to suitably achieve the operation and effect of the present invention mentioned above.

In the above structure, it is preferable that a chamfer width of the wall surface of the first block is equal to or more than 0.6 mm, and less than 3.0 mm. In accordance with the structure mentioned above, it is possible to prevent a rigidity difference per block from becoming too large so as to suppress an irregular wear from being generated, while suitably securing the suppressing effect of the groove wander.

In the above structure, it is preferable that a rate of a total of circumferential lengths of the edge portions of the wall surfaces facing to the main groove of the first blocks with respect to a circumferential length of the edge portions of the wall surface facing to the main groove of the block row is between 33 and 67%. In accordance with the structure mentioned above, the first block as mentioned above is arranged suitably, a distributing balance with respect to the second block in the tire circumferential direction becomes good, and it is possible to suitably generate the operation and effect of the present invention mentioned above.

In the above structure, it is preferable that the block row is formed by alternately arranging the first blocks and the second blocks. In accordance with the structure mentioned above, since the first block and the second block as mentioned above oppose to the rain groove alternatively next to next, it is possible to restrict the generation of the lateral force to only a brief one so as to effectively prevent the lateral force from being applied in a stationary manner, and it is possible to suitably generate the operation and effect of the present invention mentioned above evenly all around the tire circumferential direction.

### BRIEF DESCRIPTION OF THE DRAWINGS

FIG. 1 is a half plan view showing an example of a tread surface of a pneumatic tire in accordance with the present invention;

FIG. 2 is a cross sectional view as seen from an arrow A-A in FIG. 1;

FIG. 3 is a cross sectional view as seen from an arrow B-B in FIG. 1;

FIG. 4 is a plan view of a main portion showing a modification of a block row;

FIG. 5 is a plan view of a main portion showing a modification of a block row;

FIG. 6 is a cross sectional view showing a state in which an edge portion of a wall surface of a land portion drops within a rain groove, in a conventional tire;

FIG. 7 is a cross sectional view showing a chamfered wall surface of the land portion of the conventional tire; and

FIG. 8 is a cross sectional view showing a state in which a chamfered edge portion of the wall surface of the land portion drops within the rain groove, in the conventional tire.

### DETAILED DESCRIPTION OF THE PREFERRED EMBODIMENTS

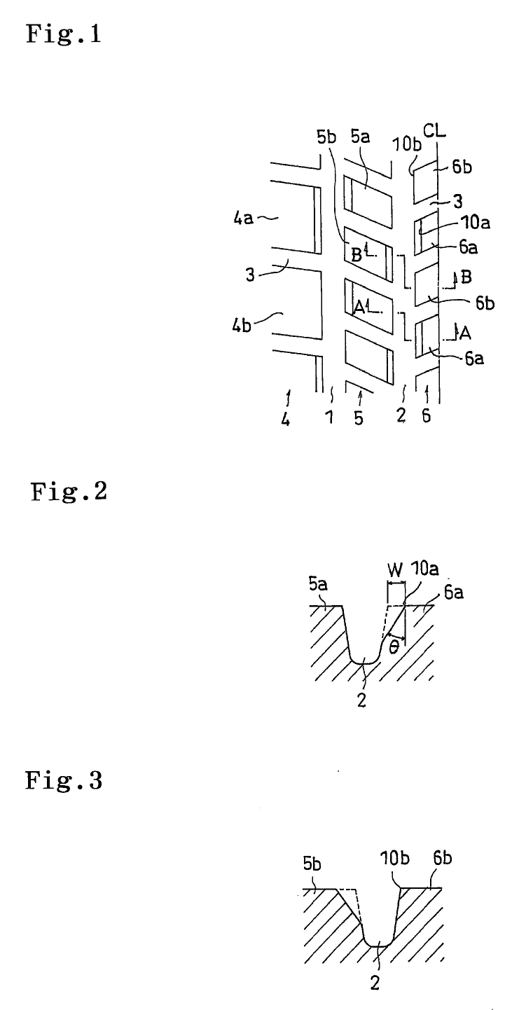

An embodiment of the present invention will be explained with reference to the drawings. FIG. 1 is a half plan view showing an example of a tread surface of a pneumatic tire in accordance with the present invention. FIG. 2 is a cross sectional view as seen from an arrow A-A in FIG. 1. FIG. 3 is a cross sectional view as seen from an arrow B-B in FIG. 1.

The tread surface is provided with a groove portion including main grooves 1 and 2 extending as a straight shape in a tire circumferential direction, and a lateral groove 3 intersecting the main grooves. A land portion is comparted into a plurality of block rows 4 to 6 by the groove portion. The block rows 4 to 6 are structured by arranging a plurality of blocks facing to the main groove 1 or the main groove 2 in a tire circumferential direction. In the present embodiment, although an illustration is omitted, the pattern is formed so as to be line symmetrical with respect to a tire equator CL, and is formed continuously in the tire circumferential direction.

In a tread pattern having the main groove extending as a straight shape in the tire circumferential direction, a great lateral force tends to be applied in a stationary manner at a time when an edge portion of a land portion wall surface (a block wall surface in the present embodiment) facing to the main groove drops within a rain groove, and it is very important to suppress a groove wander. A description will be given below of a suppressing method of the groove wander in the present embodiment by taking the wall surface facing to the main groove 2 of the block row 6 as an example.

A block row 6 has a plurality of blocks 6a (corresponding to the first block) in which a wall surface facing to the main groove 2 is chamfered, and a plurality of block 6b (corresponding to the second block) arranged between the blocks 6a and in which a wall surface facing to the main groove 2 is not chamfered, as shown in FIGS. 1 to 3. In the present embodiment, there is shown an embodiment in which the blocks 6a and the blocks 6b are alternately arranged one by one.

A planar (tapered) chamfer is formed on a wall surface facing to the main groove 2 in the block 6a, and an edge portion 10a of the wall surface is provided at an obtuse angle. On the contrary, a chamfer is not formed on a wall surface facing to the main groove 2 in the block 6b, and a position in the tire width direction of the edge portion 10b on the wall surface is differentiated from the block 6a. Accordingly, in the block row 6, the position in the tire width direction of the edge portion of the wall surface facing to the main groove 2 is not fixed, but is fluctuated per block, and is specifically fluctuated in accordance with the block 6a or the block 6b.

In accordance with the structure mentioned above, for example, even if the edge portion 10b of the block 6b drops within the rain groove at a time of traveling on the road surface on which the rain groove is formed, there is a case that the edge portion 10a of the subsequent block 6a can ground on the road surface without dropping within the rain groove. Even if the edge portion 10a of the block 6a further drops within the rain groove, a dropping amount can be differentiated because the position in the tire width direction is differentiated from the edge portion 10b of the first dropping block 6b. As a result, it is possible to restrict the generation of the lateral force to only a brief one so as to prevent the lateral force from being applied in a stationary manner, and it is possible to sufficiently suppress the groove wander so as to improve a rectilinear propagation stability.

In the present embodiment, since the blocks 6a and the blocks 6b are arranged alternately, the position in the tire width direction of the edge portion of the wall surface facing to the main groove 2 in the block row 6 is different per block, and the block 6a and the block 6b oppose to the rain groove alternately next to next. Accordingly, it is possible to restrict the generation of the lateral force to only a brief one so as to effectively prevent the lateral force from being applied in a stationary manner, and it is possible to suitably generate the operation and effect of the present invention mentioned above evenly all around the tire circumferential direction. As mentioned above, in accordance with the present invention, it is preferable that the position in the tire width direction of the edge portion of the wall surface facing to the main groove of the block row is different per block.

It is preferable that a chamfer width W of the wall surface of the block 6a is equal to or more than 0.6 mm and less than 3.0 mm, and it is more preferable that the chamfer width W is equal to or more than 1.0 mm and less than 2.4 mm. If the chamfer width W is less than 0.6 mm, a difference of the positions in the tire width direction between the edge portion 10a and the edge portion 10b becomes small. Accordingly, there is a tendency that the suppressing effect of the groove wander mentioned above becomes small. Further, if the chamfer width W is equal to or more than 3.0 mm, a rigidity difference between the block 6a and the block 6b becomes large, and there is a tendency that an irregular wear tends to be generated. In this case, the present invention is not limited to the structure in which the block wall surface is chamfered as the planar shape, but may employ a structure in which the block wall surface is chamfered as a circular arc shape.

In the case of chamfering the block wall surface as the planar shape, an angle θ of chamfer with respect to a normal direction of the tread surface is preferably equal to or more than 30 degree and equal to or less than 60 degree. If the angle θ of chamfer is less than 30 degree, it is hard to secure the chamfer width W, and there is a risk that the suppressing effect of the groove wander mentioned above becomes small. Further, if it is more than 60 degree, it is hard to secure the groove depth of the chamfered portion, and there is a risk that the portion disappears comparatively early due to the wear.

A rate of a total of circumferential lengths of the edge portions 10a of the blocks 6a with respect to a circumferential length (a length in the tire circumferential direction) of the edge portions 10a and 10b of the wall surface facing to the main groove 2 of the block row 6 is preferably between 33 and 67%, and is more preferably between 45 and 55%. Accordingly, the block 6a is suitably allocated and arranged within the block row 6, a distribution balance with the block 6b in the tire circumferential direction becomes good, and it is possible to suitably generate the operation and effect of the present invention mentioned above.

It is preferable that the block row 6 is structured such that at least one block 6a and one block 6b, more preferably, at least two or more block 6a and two or more block 6b appear within the ground length. Accordingly, an appearing frequency of the block 6a and the block 6b can be secured, and it is possible to suitably generate the operation and effect of the present invention mentioned above. In this case, the ground length indicates a length in a longitudinal direction grounded on the flat road surface at a time when a regular load is applied to the tire filled with a regular internal pressure. In this case, the regular internal pressure and the regular load are defined per tire in accordance with each of standards, in a standard system including a standard on which the tire is based. In other words, it corresponds to a maximum air pressure and a maximum load capacity in JATMA, to a maximum value described in Table “TIRE LOAD LIMITS AT VARIOUS COLD INFLATION PRESSURES” in TRA, and to “INFLATION PRESSURE” and “LOAD CAPACITY” in ETRTO, however, in the case that the tire is for a passenger car, it is set to 200 kPa and 80% of a corresponding load to 200 kPa.

The description is given to the wall surface facing to the main groove 2 of the block row 6 as an example, however, the same matter is applied to the wall surface facing to the main groove 1 or the main groove 2 in the block row 4 and the block row 5, and with or without the chamfer of the edge portion of the wall surface, the chamfer shape and the like can be structured in the same manner as mentioned above. In the present invention, the width, the angle, the shape and the like of the chamfer may be identical or different per wall surface facing to the main groove of the block row.

In the present embodiment, as shown in FIG. 1, the block row 4 is structured by alternately arranging the block 4a in which the wall surface facing to the main groove 1 is chamfered, and the block 4b in which the wall surface is not chamfered, and the block row 5 is structured by alternately arranging the block 5a in which the wall surface facing to the main groove 1 is chamfered, and the block 5b in which the wall surface facing to the main groove 1 is not chamfered. In this case, as shown in FIGS. 1 to 3, the block 5a is structured such that the wall surface facing to the main groove 2 is not chamfered, but the wall surface facing to the main groove 2 of the block 5b is chamfered. As mentioned above, in the block row 5 sandwiched by the main grooves 1 and 2, it is preferable to chamfer only one side of both wall surfaces of the blocks 5a and 5b constructing the block row 5. Accordingly, it is possible to prevent the rigidity difference per block from becoming too large, and it is possible to suitably prevent the irregular wear from being generated.

In the present invention, in order to avoid the state in which the chamfered block wall surfaces oppose to each other with respect to the main groove, it is preferable to arrange the chamfered block wall surface in a zigzag manner along the tire circumferential direction, whereby it is possible to well secure the rigidity balance in the tire circumferential direction.

The pneumatic tire in accordance with the present invention is the same as the normal pneumatic tire except the structure as mentioned above of the tread surface, and the present invention can employ any of the conventionally known material, shape, structure, manufacturing method and the like.

### Other Embodiment

(1) The tread pattern provided in the pneumatic tire in accordance with the present invention is not limited to the tread pattern shown in the embodiment mentioned above as far as the tread pattern includes the main groove extending as the straight shape in the tire circumferential direction, and the block row structured by arranging a plurality of blocks facing to the main groove in the tire circumferential direction. Accordingly, the numbers of the main groove and the block row, the shape and the size of the block and the like can be appropriately changed in correspondence to the used intended use and condition. Further, the tread pattern is not limited to be formed as the line symmetrical shape with respect to the tire equator, but may have an asymmetry.

(2) In the embodiment mentioned above, there is shown the embodiment in which the first block and the second block are alternately arranged one by one, however, the present invention is not limited to this. For example, two or more second blocks may be arranged between the first blocks, and vice versa. The arrangement of the blocks mentioned above can be appropriately set in consideration of the preferable rate of the circumferential length of the edge portion as mentioned above or the like, and this structure is useful in the case that the sizes of the blocks constituting the block row are not undifferentiated.

(3) In the embodiment mentioned above, there is shown the embodiment in which the block row is constituted by the first block in which the wall surface is chamfered, and the second block in which the wall surface is not chamfered, however, in the present invention, the wall surface facing to the main groove of the second block may be chamfered as far as the position in the tire width direction of the edge portion of the wall surface of the second block is different from the first block. In this case, in the light of largely and securely differentiating the position in the tire width direction of the edge portion of the wall surface in the second block from the first block, it is preferable that the wall surface of the second block is not chamfered, in the present invention.

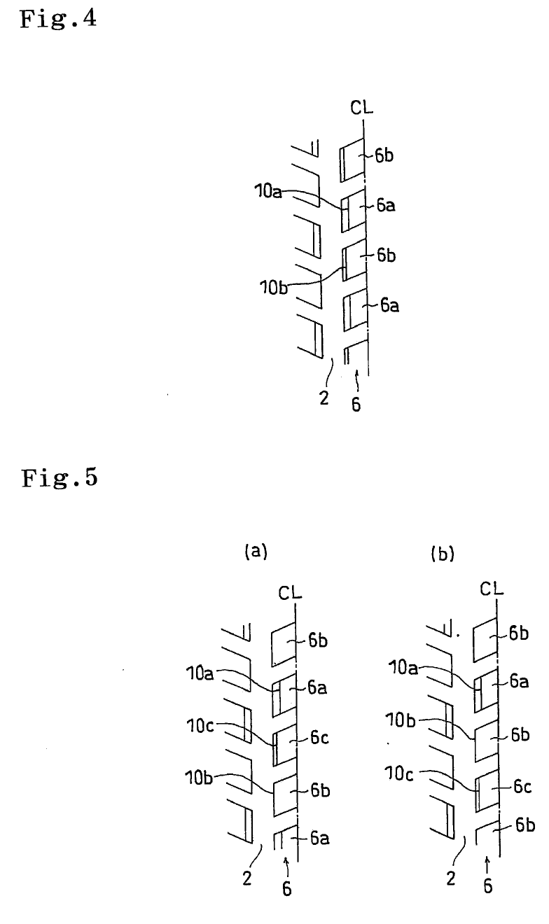

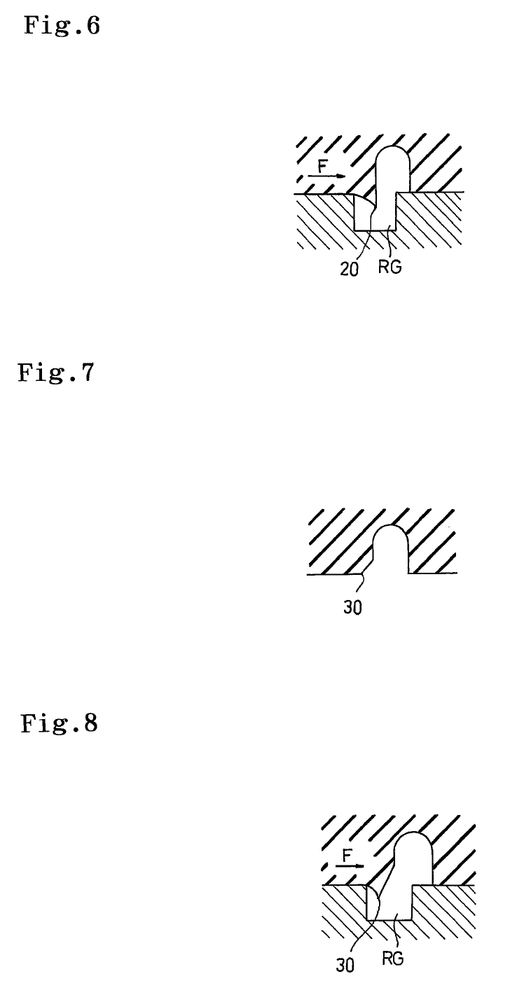

In the modification of the block row 6 shown in FIG. 4, the wall surface facing to the main groove 2 of the block 6b corresponding to the second block is chamfered. The wall surface of the block 6b is differentiated from the wall surface of the block 6a corresponding to the first block, in the width of chamfer and the angle of chamfer, thereby differentiating the positions in the tire width direction of the edge portions 10a and 10b from each other. Even in the structure mentioned above, it is possible to restrict the generation of the lateral force to only a brief one so as to prevent the lateral force from being applied in a stationary manner, and it is possible to suppress the wandering of the vehicle due to the groove wander.

(4) In the embodiment mentioned above, there is shown the embodiment in which the block row is constituted by two kinds of blocks comprising the first block, and the second block which is differentiated from the first block in the position in the tire width direction of the edge portion of the wall surface, however, the present invention may be provided with a third block in which a position in the tire width direction of an edge portion of a wall surface is differentiated from the first and second blocks. In this case, in the light of securely differentiating the position in the tire width direction of the edge portion of the block wall surface, it is preferable that the block row is constituted by two kinds of blocks in which the positions in the tire width direction of the edge portion of the wall surface are largely differentiated.

In a modified embodiment of a block row 6 shown in FIGS. 5a and 5b, the block row 6 has a block 6a corresponding to the first block, and a block 6b corresponding to the second block, and further has a block 6c corresponding to the third block. A wall surface of the block 6c is chamfered at a chamfer width which is smaller than a wall surface of the block 6b, and a position in the tire width direction of an edge portion 10c of a wall surface thereof is differentiated from edge portions 10a and 10b of the blocks 6a and 6b. Even in the structure mentioned above, it is possible to restrict the generation of the lateral force to only a brief one so as to prevent the lateral force from being applied in a stationary manner, and it is possible to suppress the wandering of the vehicle due to the groove wander.

### Example

An example tire which concretely shows the structure and effect of the present invention will be explained. An evaluation of each of performances is executed as follows.

### (1) Groove Wander Resistance

A tire is installed to an actual car (SUV) and is set to an air pressure 260 kPa, and a feeling evaluation on the basis of a feeling test is carried out by traveling straight on a road surface on which the rain groove is formed. A comparative example 1 is set to 100 and a result is evaluated with indices, the more the numeric value is, the more excellent the groove wander resistance is.

### (2) Hydroplaning Resistance

The tire is installed to the actual car (SUV) and is set to the air pressure 260 kPa, and a speed at a time when a hydroplaning phenomenon is generated is measured by traveling on a straight course having a wet road surface of water depth 8 mm. An evaluation is shown by an index number in the case of setting a comparative example 1 to 100, and indicates that the larger the numerical value is, the better the hydroplaning resistance is.

### (3) Irregular Wear Resistance

The tire is installed to the actual car (SUV) and is set to the air pressure 260 kPa, and a difference of wear amount between the first block and the second block is measured by traveling on a general road for 12000 km. An evaluation is shown by an index number in the case of setting a comparative example 1 to 100, and indicates that the larger the numerical value is, the better the irregular wear resistance is.

### (4) Handling Performance

The tire is installed to the actual car (SUV) and is set to the air pressure 260 kPa, and a feeling evaluation on the basis of a feeling test is carried out by executing a straight traveling, a turning traveling, a braking and the like on a road surface on which the rain groove is not formed. A comparative example 1 is set to 100 and a result is evaluated with indices, the more the numeric value is, the more excellent the handling performance is.

### Examples 1 to 3 and Comparative Examples 1 to 3

The pneumatic tires having the tread pattern as shown in FIGS. 1 to 3 are set to examples 1 to 3. Further, a comparative example 1 is set to the pneumatic tire in which all the block wall surfaces are not chamfered in the tread pattern shown in FIG. 1, a comparative example 2 is set to the pneumatic tire in which all the block wall surfaces are not chamfered and all the main grooves are extended in a zigzag shape, and a comparative example 3 is set to the pneumatic tire in which all the block wall surfaces are chamfered. In this case, the tire sizes are all set to 305/40R22. Results of the evaluation are shown in Table 1.

TABLE 1

| | | | Width | | | | | |
|---|---|---|---|---|---|---|---|---|
| | Shape of | | of | Angle of | Groove | | Irregular | |
| | main | | chamfer | chamfer | wander | Hydroplaning | wear | |
| | groove | Chamfering | (mm) | (°) | resistance | resistance | resistance | Handling |
| Example 1 | Straight | One by | 1.5 | 45 | 130 | 100 | 100 | 100 |
| | | one | | | | | | |
| Example 2 | Straight | One by | 0.5 | 45 | 105 | 100 | 100 | 100 |
| | | one | | | | | | |
| Example 3 | Straight | One by | 3.5 | 45 | 130 | 100 | 70 | 85 |
| | | one | | | | | | |
| Comparative | Straight | None | None | None | 100 | 100 | 100 | 100 |
| Example 1 | | | | | | | | |
| Comparative | Zigzag | None | None | None | 140 | 60 | 95 | 100 |
| Example 2 | | | | | | | | |
| Comparative | Straight | Continuous | 1.5 | 45 | 105 | 100 | 100 | 90 |
| Example 3 | | | | | | | | |

In the comparative example 1, since the groove wander countermeasure is not particularly employed, the groove wander resistance is comparatively low. Further, in the comparative example 2, in spite that it is possible to well suppress the groove wander by extending the main groove in the zigzag manner, the drain performance is lowered. Further, in the comparative example 3, it is possible to suppress the groove wander by chamfering all the block wall surfaces, however, since there is the case that the edge portion provided by chamfering drops within the rain groove so as to generate the lateral force, the improving effect is not great.

On the contrary, all the examples 1 to 3 can well suppress the groove wander while securing the drain performance. The improving effect is particularly great in the examples 1 and 3, and it can be that the chamfer width of the block wall surface is preferably equal to or more than 0.6 mm. Further, in the example 3, it can be that the irregular wear resistance and the handling performance are comparatively low due to the rigidity difference between the blocks and the reduction of the ground area, and the chamfer width of the block wall surface is preferably less than 3.0 mm. In addition, in the examples 1 and 2, it is possible to achieve a more excellent handling performance in comparison with the comparative example 3, while suppressing the reduction of the ground area.

What is claimed is:

1. A pneumatic tire in which a tread surface is provided with a main groove extending as a straight shape in a tire circumferential direction, and a block row formed by arranging a plurality of blocks facing to the main groove in the tire circumferential direction,
wherein the block row has a plurality of first blocks in which a wall surface facing to the main groove is chamfered, and a plurality of second blocks arranged between the first blocks and in which a position in a tire width direction of an edge portion of a wall surface facing to the main groove is differentiated from the first block.

2. A pneumatic tire according to claim 1, wherein the second block is structured such that a wall surface facing to the main groove is not chamfered.

3. A pneumatic tire according to claim 2, wherein a chamfer width of the wall surface of the first block is equal to or more than 0.6 mm, and less than 3.0 mm.

4. A pneumatic tire according to claim 1, wherein a rate of a total of circumferential lengths of the edge portions of the wall surfaces facing to the main groove of the first blocks with respect to a circumferential length of the edge portions of the wall surface facing to the main groove of the block row is between 33 and 67%.

5. A pneumatic tire according to claim 4, wherein the block row is formed by alternately arranging the first blocks and the second blocks.
